(19) United States
(12) Patent Application Publication
(10) Pub. No.: US 2011/0120885 A1
(43) Pub. Date: May 26, 2011

(54) COOLING TOWER WATER MANAGEMENT SYSTEM

(75) Inventors: Robert S. Miller, Park Ridge, IL (US); Robert C. Warnecke, Kildeer, IL (US)

(73) Assignee: Earthwise Environmental Inc., Beneseville, IL (US)

(21) Appl. No.: 12/946,749

(22) Filed: Nov. 15, 2010

Related U.S. Application Data
(60) Provisional application No. 61/281,339, filed on Nov. 16, 2009.

(51) Int. Cl. C02F 1/461; C25B 9/00

(52) U.S. Cl. 205/743; 204/230.2; 204/230.5; 204/275.1; 204/228.1

(57) ABSTRACT

A cooling tower water management system is disclosed. A water treatment module is positioned in a water circulation line in a cooling tower. The water treatment module comprises a treatment cell having a cathodic tube and an anodic rod within the tube. A controller and power supply create a pulsed electrical potential across water in the treatment cell from the cathode to the anode to perform electrolysis on the water. Suspended and dissolved solids in the water are built up on a surface within the treatment cell. The controller can initiate a regeneration cycle to remove the built up solids from the surface. The regeneration comprises switching the electrical contact from the anode to a portion of the cathodic tube.

### CROSS-REFERENCE TO RELATED APPLICATIONS

This application claims priority to U.S. Provisional Application No. 61/281,339, filed on Nov. 16, 2009 and incorporated herein by reference in its entirety.

### TECHNICAL FIELD

This disclosure relates to an electrolytic water treatment module and associated systems and methods for use with cooling towers.

### BACKGROUND

Water-based cooling towers are commonly used to remove excess heat from buildings, factories, and industrial equipment. The water absorbs unwanted heat, and the heated water is piped to a cooling tower where the water transfers the heat to the air through a system of evaporators, louvers, etc. Frequently the cooling towers are placed on a roof of a building where they can be seen venting heat and steam into the air. The cooling towers use the relatively high latent heat of evaporation of water to transfer heat into the air. Cooling towers cool water through evaporative and convection cooling principles. At the actual point of heat exchange with the process medium there will be some loss of water due to evaporation. The tower return water containing heat picked up at the point of heat exchange with the chillers or process load is cooled for return to the tower fill/supply reservoir or sprays. This water is distributed uniformly over the tower system. The tower breaks up the water to small droplets which flow through the fill. At the same time air is flowed across the water. As the air and water contact each other evaporation takes place. During the evaporation process, heat is removed from the cooling tower water equivalent to the latent heat of vaporization, which in turn cools the process medium.

The latent heat of evaporation is equivalent to 1,000 BTU per pound of water evaporation. In general this is equivalent to 1 degree F. drop in cooling water for each 0.1% of water evaporated. The following formula is used to determine evaporation in a cooling tower system:

Evaporation=0.1%×delta T×Recirculation Rate,GPM
E=0.001×delta T×R, where delta T=Temperature Drop and R=recirculation rate of the condenser water pumps in GPM.

The following is an example of tower evaporation with tower return temperature at 950 F and discharge temperature at 850 F. The tower water recirculation rate is 3,000 GPM.

E=0.001×(950 F-850 F)×3,000 GPM

E=0.001×10×3000 GPM

E=30 GPM

The water in these cooling towers is generally supplied by the municipal water supply, and so it carries solids and other suspended or dissolved substances. The water that evaporates into the air does not, however, carry any of these substances with it. As the water cycles through the cooling tower, the concentration of these substances in the water increases. Gradually, the efficiency of the cooling tower decreases and the concentration of suspended or dissolved solids in the water increases. Make-up water is needed to compensate for the evaporated water, but in many applications water is expensive or difficult to obtain. The following relationships exist between make-up water, evaporation, and bleed-off:

Make-up (contains impurities)=Evaporation (no impurities)+Bleed-off (contains concentrated impurities)

Or:

Make-up=Evaporation+Bleed-off

The equation for bleed-off is then:

Bleed-off=Evaporation/(cycles of concentration−1)

Thus for a system used above and concentrating the solids three times the bleed-off rate would be:

Bleed-off=30/(3−1)=15 GPM or

Make-up=30 GPM Evaporation+15 GPM Bleed-off

Make-up=45 GPM

In general terms, there are problems presented by operations of the type just described. When water is bled off it is discharged into the municipal water system, this is a waste of water and requires introducing an amount of makeup water to the cooling tower supply resulting in an overall increase in the volume of water required for the operation of the cooling tower. Moreover, the water being discharged returns dissolved and suspended solids to municipal water system, and in a more concentrated form than when withdrawn from the municipal water system.

Even with water treatment as discussed above there are constraints on time of additive exposure in the water and on the quantity of the particular additive which must be adhered to insure against solids coming out of solution. In most cases, these additives are undesirable as unwanted chemicals and their concentration in the water supply must be closely monitored, especially as it is discharged to the municipal water system.

Current water treatment programs fall into two categories: acid-based and carbonate-based. In acid-based systems, the acid normally used is sulfuric and is either used as a straight additive or mixed with inhibitors and dispersants or polymers. Acid based systems have limits based on forming calcium sulfate deposits. Carbonate-based systems use polymers and dispersants to keep contaminants in system water in solution. This program has limits based on system water alkalinity and hardness levels.

Typical current cooling tower systems operate at between 2.5-5 cycles of concentrations before the water should be rejuvenated. More particularly, a cycle is determined by dividing the amount of water that has been used as make up water by amount that has bled off. Many applications are based on a time cycle, independent of any monitoring of the condition of the water in the system. For example, some systems are rejuvenated once per day, regardless of the condition of the water. This is an inefficient way to proceed because either the water concentration is high and rejuvenation should be performed more frequently, or the water concentration is low so rejuvenation should be performed less frequently.

### BRIEF DESCRIPTION OF THE FIGURES

FIG. 1 is a partially schematic diagram of a cooling tower system and water treatment module configured in accordance with the present disclosure.

FIG. 2 is a schematic illustration of a treatment cell for use with a water treatment module configured in accordance with the present disclosure.

FIG. 3 is a graph of voltage and amperage according to a control routine of the present disclosure.

FIG. 4 is an illustration of a wall of a treatment cell configured in accordance with the present disclosure.

FIG. 5 is an isometric illustration of a portable water treatment module configured in accordance with the present disclosure.

FIG. 6 is a flow chart diagram of a control routine for use with a water treatment module configured in accordance with the present disclosure.

### DETAILED DESCRIPTION

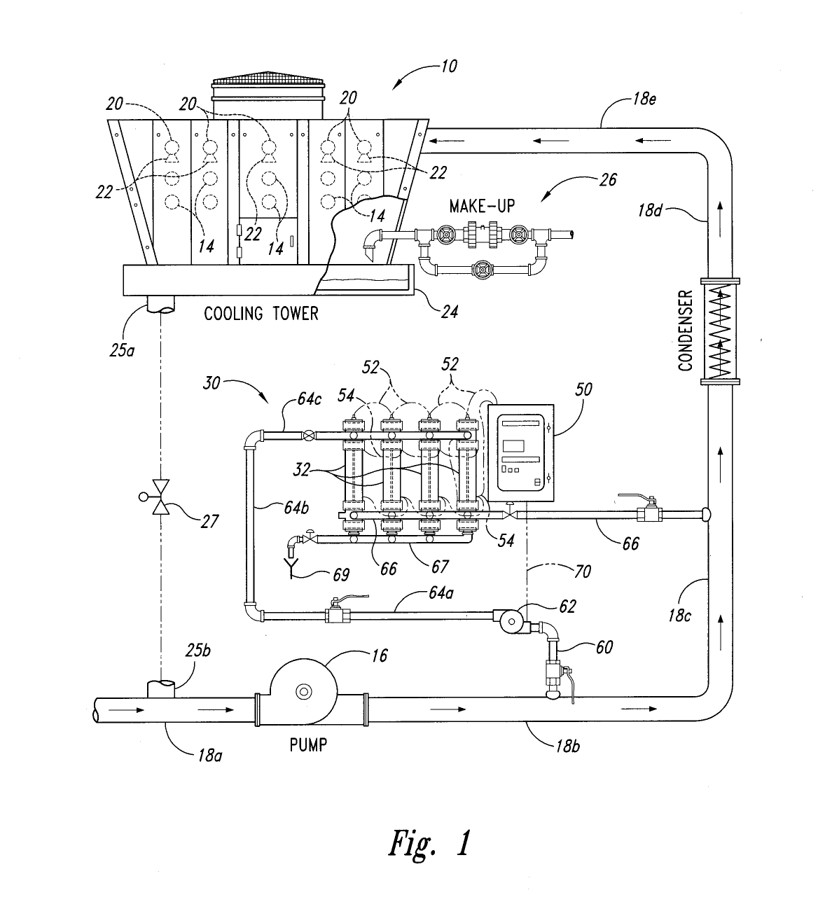

FIG. 1 is a schematic illustration of a water management system 10 in accordance with embodiments of the present disclosure. The system 10 includes a network of piping 14 within a housing 12. A process medium flows through the network of piping 14, and is cooled by water that is drawn from a source such as municipal water system and is propelled through piping 18a, 18b, 18c, 18d, and 18e to the upper portion of a cooling tower 15 by a pump 16.

The cooling tower 15 includes an array of pipes 20 with spray nozzles 22 above the piping 14. The details of the cooling tower 15 are not fully given here, but are generally understood in the art. Some of the water evaporates into the atmosphere and is lost. Water not lost through evaporation returns to a reservoir 24 and is recycled through the system 10. The water in the reservoir 24 is returned to the main water supply via piping 25a and 25b as desired and controlled by a valve 27. To compensate for water evaporated or otherwise lost in the cooling operation, make-up water is periodically introduced into the system as needed through make-up piping 26 that can lead to the reservoir 24 or to another part of the cycle.

The water that evaporates is pure, but the make-up water is not. Overtime, the water in the system becomes highly concentrated with deleterious suspended and dissolved materials. In conventional systems the cooling water is periodically purged from the system and into the municipal water system. This purging is inefficient, costly, and has a negative effect on the quality of the municipal water supply. Moreover, as the frequency of the purging increases the inefficiency, lack of cost, and the negative impact is compounded.

The system 10 can include a water treatment module 30. The water treatment module 30 can have an inlet 60 that receives water from piping 18b, and an outlet 66 that returns the water after treatment back to the piping 18c. Water from the main water supply is diverted to the cell 32 by conduits 60, pump 62, and conduits 64a, 64b, and 64c. The power source 50 can be used to drive the pump 62 through a line 70. The module includes one or more cells 32. Four cells are illustrated in FIG. 1, but any suitable number of cells 32 can be used depending on the needs of the system 10. The power source 50 can be electrically connected to the cells through electrical lines 52 and 54. In some embodiments the module 30 is portable and can be moved from location to location and incorporated into piping of a cooling tower as needed. A portable version of the module 30 is shown mounted on skids in FIG. 5.

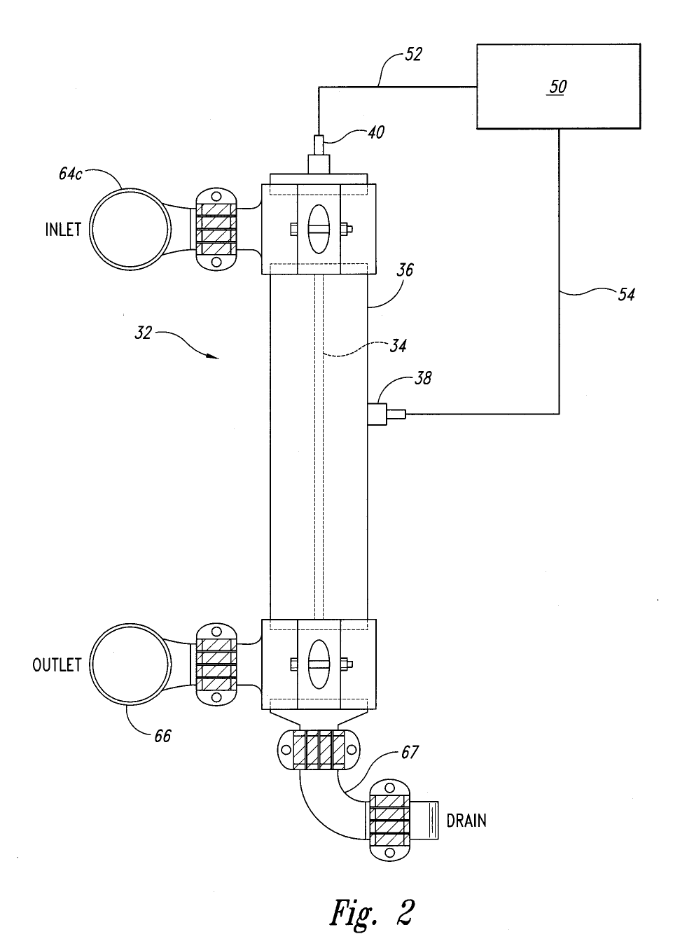

FIG. 2 illustrates a water treatment cell 32 of the water treatment module 30 shown with reference to FIG. 1 above in accordance with embodiments of the present disclosure. The water treatment module 30 can include any suitable number of cells 32. For purposes of brevity, a single cell 32 is described. The cell 32 includes a cylinder 36 and a rod 34 supported on the centerline of the cylinder 36. The rod 34 is made from a mixed metal alloy, for example a titanium core coated with a rare earth material. The rare earth coating allows the rod to give of an electron during an electrolysis process without disintegrating. The cylinder 36 is made of a conductive material such as stainless steel. The power source 50 is electrically connected through a line 52 to a fitting 40 which is in turn connected to the rod 34. The power source 50 is also electrically connected to the cylinder 36 by another fitting 38 through another line 54. In embodiments having multiple cells 32, individual cells 32 can be taken online or offline individually for cleaning or maintenance or repair without affecting other cells 32 in the module 30.

When the power source applies a voltage, the rod 34 is an anode and the tube 36 is a cathode. As the water flows from one end of the cylinder 36 to the other end while the voltage is applied, the water undergoes an electrolytic process that breaks water down. In some embodiments, the voltage is between approximately 10-100 volts generating 10-20 amps. At the anode, hydrogen (H) is generated as a gas that can be vented from the cell and captured for disposal or use elsewhere. At the cathode, hydroxide (OH) is generated. The hydroxide reacts with caustic materials in the water, such as calcium and magnesium, to form calcium and magnesium carbonate. The calcium and magnesium carbonates adhere to the inner wall of cylinder 36 and form a gummy, paste-like substance. Organics in the water will also bind with the calcium and magnesium carbonate and thus are desirably removed from the cooling water supply. The treated water leaves the cell 32 cleaner, softer, and less prone to producing scale, corrosion or other harmful effects.

Some of the organics are captured in the carbonates at the cathode (cylinder 36). In addition, municipal water usually contains some amount of salt (NaCL). The hydroxide generated in the cell will react to come degree with the salt and generate an amount of sodium hydroxide (NaOH) and chlorine (CL). That chlorine is then available for use in treating some of organics contained in water. Since that chlorine is coming from a source that was already present in the water supply it is not considered a negative. Furthermore, since the system reduces or eliminates the need to discharge cooling water to the municipal water system, the overall contribution of contaminants is reduced compared to conventional systems.

In some cooling tower installations, the treatment of organics inherent in the use of this disclosure and as described hereinabove is sufficient to treat any organics that may be present in the water supply. If additional organic treatment is necessary the system of this disclosure can be used conveniently with apparatus such as those described in U.S. Pat. Nos. 6,126,820 and 6,325,944 B1, which are incorporated herein in their entirety.

The power source 50 can deliver a pulsed voltage to the cells 32 as opposed to constant voltage. The pulsed voltage can be a series of alternating ramp-up and ramp-down periods. The pulse width can vary. FIG. 4 illustrates a coating 100 on walls of the cylinder 36 is a constant voltage supply is used. The irregular thickness requires more power for proper operation as compared to a coating of relatively uniform thickness. The need for a higher amperage degrades the operation and also shortens the time between cell regeneration. A pulsed power source 50, however, results in a coating of relatively uniform thickness, shown by the dotted line 102 in FIG. 4. In an embodiment, the pulsed power source 50 can be a Micro-Star SCR type power source.

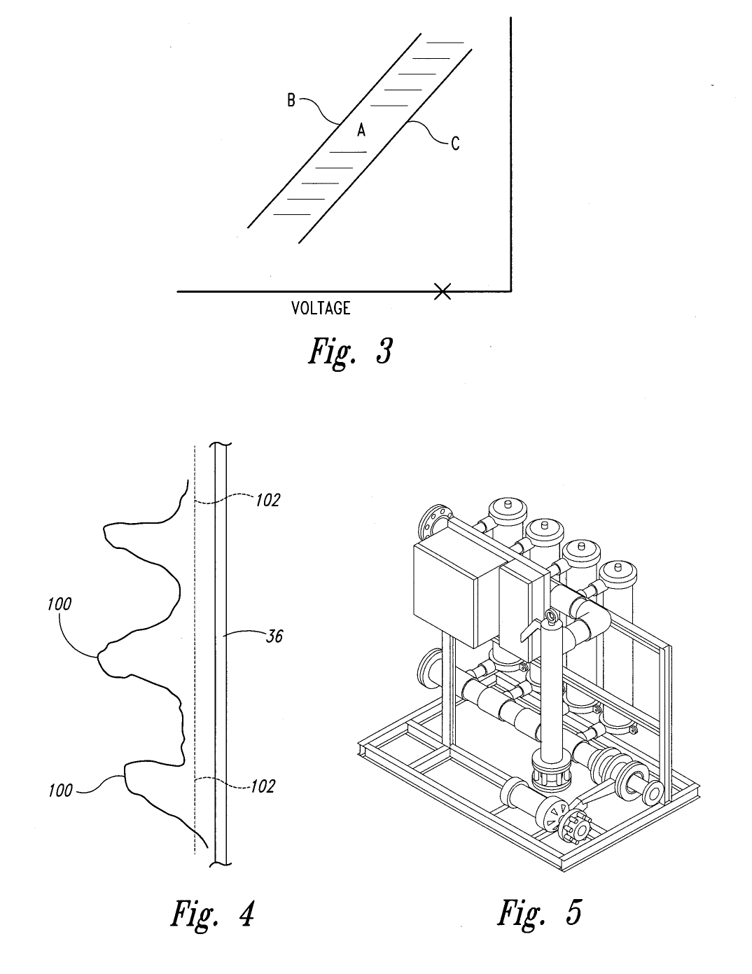

FIG. 3 illustrates a relationship between build-up and voltage, with voltage represented along the x-axis and build-up represented by the y-axis. The more build-up on the cylinder walls, the more voltage is required to maintain a desirable, constant amperage. There is a range A between lines B and C in which a preferred result is achieved.

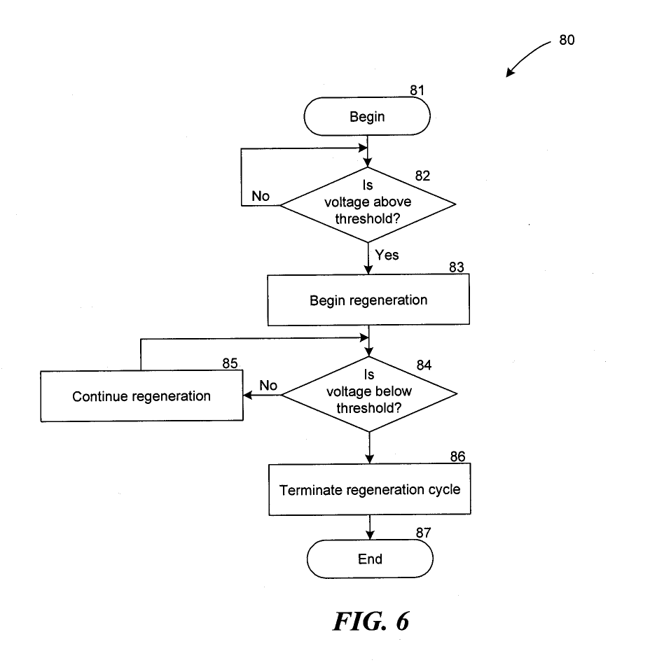

FIG. 6 illustrates a control routine 80 for initiating and terminating a regeneration cycle in accordance with embodiments of the present disclosure and according to the relationship shown in FIG. 3. The routine 80 can be executed by a controller 53 shown schematically in FIG. 1. The controller 53 can be a programmable logic controller or another equivalent device. At step 81, the control routine 80 can begin. At step 82, the controller 53 can determine whether the voltage required by the system to maintain a constant amperage has reached a predetermined threshold value. The controller 53 can include appropriate amp and voltage sensors and measuring equipment. The actual value of the threshold can vary with the size and configuration of the module 30. If the voltage is below the threshold, the routine 80 can wait a certain time before checking the voltage level again. In areas where the municipal water supply is relatively free from solids, this process can extend much longer than in other areas. This is an advantage over other systems that regenerate based on time alone, without determining a need for the regeneration cycle. It is also more cost-effective than directly measuring the dissolved or suspended solids currently present in the water.

If the predetermined voltage threshold is met, the control routine 80 can begin a regeneration cycle 83. In some embodiments, the regeneration cycle can be performed by switching the lead 52 (FIG. 2) from the anode to a portion of the cylinder 36. This causes a “dead short” between the power source 50, the lines 52, and 54, and the cylinder 36. The dead short knocks the build-up off the walls of the cylinder 36 and into the water. The water in the treatment cell 32 can then be disposed of properly.

In some embodiments, the routine 80 can run the regeneration cycle 83 for a predetermined period of time and then refresh the routine at step 81. In other embodiments, during the regeneration cycle 83, the controller 53 can monitor a voltage level in the treatment cell 32. At step 84, if the voltage has not dropped below a predetermined voltage threshold, the regeneration cycle can continue at step 85. Otherwise, once the voltage drops below the threshold the regeneration cycle can be terminated 86 and the routine 80 can terminate at step 87. In embodiments in which the regeneration cycle 83 is performed by the dead short, step 84 can include switching the lead 52 back to the anode and running current for a short time to measure voltage across the electrolytic gap between the anode and cathode. If the voltage is not below the threshold, the lead 52 can switch back to the cathode and continue the dead short operation.

Using the water treatment module 30 maintains the concentration of dissolved and suspended solids in the cooling water at a lower, more tolerable level and the same water can be used for more cycles before requiring a purge than other cooling tower systems. In some embodiments, the purge and replacement cycles can be eliminated. The water management system is more sustainable because the only make-up water needed is equal to an amount lost through evaporation. The need to discharge water having a high concentration of solids after use in cooling tower is reduced or eliminated. The actual volume of water discharged is reduced and what is discharged contains fewer contaminants. The load on the municipal water system is reduced.

The substances that builds up within the cells is collected in the cells and must be discharged periodically. This can be done by taking the cell offline and flushing with water and/or a suitable cleansing agent. The removed deposits are easily captured and contained for safe disposal. The deposits and the flushing water can be directed to a drain 69 (FIG. 1) through an outlet pipe 67 into either the municipal water system or to a container for capture.

From the foregoing, it will be appreciated that specific embodiments of the disclosure have been described herein for purposes of illustration, but that various modifications may be made without deviating from the spirit and scope of the disclosure. Additionally, aspects of the disclosure described in the context of particular embodiments or examples may be combined or eliminated in other embodiments. Although advantages associated with certain embodiments of the disclosure have been described in the context of those embodiments, other embodiments may also exhibit such advantages. Additionally not all embodiments need necessarily exhibit such advantages to fall within the scope of the disclosure.

I/We claim:

1. A water treatment module comprising:
at least one water treatment cell having an inlet configured to receive water having impurities and an outlet configured to dispense water after treatment, wherein the water treatment cell at least partially forms a cathode;
an anode disposed in the water treatment cell;
a power supply operably coupled to the cathode and the anode; and
a controller operably coupled to the power supply, wherein the controller controls the power supply to deliver pulsed electrical potential between the anode and the cathode, thereby causing electrolysis in the treatment cell to treat the water therein.

2. The water treatment module of claim 1 wherein solids resulting from the electrolysis process build up on the interior wall of the water treatment cell, and wherein the controller is configured to initiate a regeneration cycle in which the solids are removed from the interior wall by switching the voltage from the anode to a portion of the cathode.

3. The water treatment module of claim 2, further comprising a discharge line operably connected to the treatment module, wherein the controller is configured to direct water in the treatment module during the regeneration cycle through the discharge line.

4. The water treatment module of claim 1 wherein the control system is configured to regulate the power supply to deliver a generally constant amperage to the treatment cell and to vary a voltage delivered to the treatment cell.

5. The water treatment module of claim 4 wherein the voltage required to maintain a constant amperage is proportional to an amount of built up solids on the interior wall of the treatment cell, the system further comprising a voltage sensor configured to detect a voltage applied by the power supply, wherein the controller is configured to initiate a regeneration cycle if the voltage increases above a predetermined threshold.

6. The water treatment module of claim 1 wherein the treatment cell comprises a cylinder and the anode comprises a rod disposed within the cylinder.

7. The water treatment module of claim 1 wherein the anode is composed of a rare earth metal mix coated on a titanium core.

8. The water treatment module of claim 1 wherein the treatment cell comprises a plurality of treatment cells arranged in parallel.

9. The water treatment module of claim 1 wherein the treatment module comprises a self-contained, portable unit configured to adapt to the circulation pipe of different cooling towers.

10. The water treatment module of claim 1 wherein the controller is configured to monitor a voltage level and amperage delivered to the treatment cell.

11. A water treatment system, comprising:
a cooling tower having a heat exchanger and a recirculation pipeline;
a water treatment module having a cathode and an anode, wherein the water treatment module is configured to receive water from the recirculation pipeline, direct the water between the cathode and the anode, and return the water to the recirculation pipeline after treating the water; and
a power supply configured to deliver a pulsed electrical potential between the cathode and the anode to cause electrolysis in the water treatment module, wherein the electrolysis causes solids in the water to build up on an interior surface of the cathode.

12. The system of claim 11 wherein the cathode comprises a cylindrical tube and the anode comprises a rod extending at least generally centrally within the tube.

13. The system of claim 11 wherein the pulsed electrical potential comprises alternating periods of increasing voltage and decreasing voltage in a sine wave.

14. The system of claim 11 further comprising a controller configured to monitor a voltage applied by the power supply and to maintain a generally constant amperage applied by the power supply, and wherein the voltage reaches a predetermined threshold the controller is configured to initiate a regeneration cycle.

15. A method of operating a cooling tower, the method comprising:
directing a portion of water in a cooling tower cycle through a treatment cell comprising a cathode and an anode;
applying a pulsed electrical potential to the anode and a first portion of the cathode, and causing suspended and dissolved materials in the water to adhere to the cathode within the treatment cell, wherein the pulsed electrical potential comprises a generally constant amperage and a variable voltage;
monitoring the variable voltage; and
if the variable voltage reaches a predetermined threshold, initiating a regeneration cycle, wherein the regeneration cycle comprises applying the electrical potential to the first portion of the cathode and a second portion of the cathode.

16. The method of claim 15 further comprising stopping the regeneration cycle after a predetermined time.

17. The method of claim 15, further comprising:
monitoring the voltage during the regeneration cycle; and
if the voltage drops below a predetermined threshold, terminating the regeneration cycle.

18. The method of claim 15, further comprising discharging water in the treatment cell during the regeneration cycle.

19. The method of claim 15 wherein directing the water through the treatment cell comprises directing the water through a plurality of cylindrical shells arranged in parallel.

20. The method of claim 15, further comprising returning the water from the treatment module to the cooling tower cycle.

21. The method of claim 15 wherein the pulsed electrical potential comprises ramp-up periods and ramp-down periods, and wherein the materials in the cell build up in the cell during the ramp-up periods to form an irregular coating, and further wherein the irregular coating forms a generally uniform coating during the ramp-down periods.
